(19) United States
(12) Patent Application Publication
(10) Pub. No.: US 2022/0351107 A1
(43) Pub. Date: Nov. 3, 2022

(54) AUTOMATED REQUEST FULFILMENT PROCESSING

(71) Applicant: Shopify Inc., Ottawa (CA)

(72) Inventors: Ugnius SINONIS, Vilnius (LT); Sandra SAUKAITE, Vilkaviskio (LT); Jule JANKAUSKAITE, Vilnius (LT)

(73) Assignee: Shopify Inc., Ottawa (CA)

(21) Appl. No.: 17/244,198

(22) Filed: Apr. 29, 2021

(51) Int. Cl. G06Q 10/06; G06Q 10/08; G06Q 30/02; G06N 20/00; G06N 5/04

(52) U.S. Cl. CPC G06Q 10/06313; G06Q 10/06315; G06Q 10/087; G06Q 10/08345; G06Q 30/0206; G06N 20/00; G06N 5/04

(57) ABSTRACT

Methods and systems for automated request fulfilment processing. A computer system receives a plurality of requests for resources, each request being for a respective resource and having an associated latest time for fulfilment of the request and it periodically, for unfulfilled requests among the plurality of requests, determines, using a machine learning model, for each unfulfilled request, an predicted cost of fulfilment of the unfulfilled request at times between a current time and the associated latest time for the unfulfilled request. It then identifies, from among the unfulfilled requests, one or more unfulfilled requests for which its lowest predicted cost of fulfilment is at a time matching the current time, and transmits a request to a resource supplier of the respective resource to fulfil the identified one or more unfulfilled requests.

### TECHNICAL FIELD

The present disclosure relates to online commerce events and, in particular, methods and systems for automatically processing requests for fulfilment.

### BACKGROUND

In certain systems, a server or other computing platform may be configured to receive a plurality of requests for resources where each request has an associated “latest fulfilment time”, where the latest fulfilment time indicates a time and/or date that is the latest time at which fulfilment of the request should or may occur. The request for resources to the computing platform may be one that is fulfilled by an external resource fulfilment source, rather than by the computing platform itself. In this sense, the computing platform is to request or instruct the external resource fulfilment source to complete fulfilment of the request to the requestor by provisioning or providing the requested resource. Accordingly, the server or computing platform may immediately transmit a request to the external resource fulfilment source to fulfil the request. However, in some situations, this may result in a suboptimal outcome.

If a large quantity or spike in requests for a service or product or other resource are received in a short time period, a corresponding large quantity or spike in orders may be sent to the external resource fulfilment source. This may overwhelm some sources, result in changes in cost or rejection of some orders, or result in failure of some services. As an example, a sudden large quantity of orders to a content delivery network may overwhelm available resources and result in refusal of some requests and/or a deterioration in quality of service, due to overwhelming of the bandwidth or processing resources available. This may occur despite the fact the requests have associated latest fulfilment times that could permit deferral of some orders to the external resource fulfilment source.

### BRIEF DESCRIPTION OF THE DRAWINGS

Embodiments will be described, by way of example only, with reference to the accompanying figures wherein:

FIG. 1 shows an example timeline associated with a resource request and fulfilment;

FIGS. 2A and 2B shows example time series of predicted costs for a resource request fulfilment;

FIG. 3 shows an example cost prediction engine;

FIG. 4 shows a simplified example of a system for automated request fulfilment processing;

FIG. 5 shows, in flowchart form, one example method of automated request fulfilment processing;

FIG. 6 shows, in flowchart form, another example method of automated request fulfilment processing;

FIG. 7 shows, in flowchart form, yet a further example method of automated request fulfilment processing;

FIG. 8 is a block diagram of an e-commerce platform, according to an example embodiment; and

FIG. 9 is an example of a home page of an administrator, according to an example embodiment.

### DETAILED DESCRIPTION

In an aspect, the present application discloses a computer-implemented method for automated request processing. The method may include receiving, by a computer system, a plurality of requests for resources, each request being for a respective resource and having an associated latest time; and periodically, for unfulfilled requests among the plurality of requests, determining, using a machine learning model, for each unfulfilled request, an predicted cost of fulfilment of the unfulfilled request at times between a current time and the associated latest time; identifying, from among the unfulfilled requests, one or more unfulfilled requests for which its lowest predicted cost of fulfilment is at a time matching the current time; and transmitting a request to a resource supplier of the respective resource to fulfil the identified one or more unfulfilled requests.

In some implementations, the automated request processing methods and systems described herein may advantageously avoid spoilage or costs associated with mis-timed supply of input resources, such as to an industrial process. In some cases, the methods and systems controlling request processing may facilitate advantageous modulation of request rates or volume to ensure a smoothing of request rates and consequent gains in efficiency of processing or delivery. Improvements aimed at minimizing storage time, avoiding spoilage, smoothing demand or request rates, avoiding pricing anomalies, or minimizing resource costs may been generally referred to as “cost” minimization in some portions of the description below, wherein “cost” may include any negative externalities relating to the process to which the resource is directed.

In some implementations, the associated latest time includes a latest order time, and wherein each request for resources includes a latest fulfilment time, and wherein the method further includes determining, for each request, its associated latest order time based on the latest fulfilment time less an expected latency time. In some cases, the expected latency time is an expected time from transmission of the request to the resource supplier to provisioning of the respective resource to a requestor associated with the request. In some of those implementations, the expected time includes a shipping time and is based, in part, on a shipping modality, and wherein the resource supplier permits one or more shipping modalities for the respective resource. Each of the one or more shipping modalities may have respective associated cost and expected latency time, and determining may include selecting one of the one or more shipping modalities having an expected latency time that would result in provisioning of the respective resource to the requestor within the latest fulfilment time.

In some implementations, determining predicted cost of fulfilment includes determining a first predicted cost of fulfilment of a first of the unfulfilled requests and determining a second predicted cost of fulfilment of the first of the unfulfilled requests if combined with a second of the unfulfilled requests directed to the same identified resource.

In some implementations, the predicted cost of fulfilment includes determining a predicted supplier price for the respective resource at a future time and a predicted delivery cost. Predicted delivery cost may include a predicted shipping cost. Predicted supplier price may be at least partly based on a current price and a supplier pricing model associated with the resource supplier. The supplier pricing model may be based on one or more of calendar data and year-over-year historical pricing data. The supplier pricing model may further be based on one or more of sales volume data relating to the respective resource, order volume data associated with the resource supplier, industry volume data for an industry related to the respective resource, year-over-year historical pricing data associated with an industry related to the respective resource, year-over-year historical pricing data associated with the respective resource, or year-over-year historical pricing data associated with the resource supplier.

In some implementations, periodically includes daily, the current time is a current day, the associated latest time is an associated latest date, and wherein determining the predicted cost of fulfilment of the unfulfilled request at times includes determining the predicted cost of fulfilment of the unfulfilled request at dates from the current day to the associated latest date.

In some implementations, periodically includes at a time when a trigger event is detected. The trigger event may include detecting a deviation in current cost of fulfilment from a previously-predicted cost of fulfilment at the current time by more than a threshold amount.

In another aspect, the present application discloses a computing system. The computing system includes a processor and a memory storing computer-executable instructions that, when executed, are to cause the processor to receive a plurality of requests for resources, each request being for a respective resource and having an associated latest time; and periodically, for unfulfilled requests among the plurality of requests: determine, using a machine learning model, for each unfulfilled request, an predicted cost of fulfilment of the unfulfilled request at times between a current time and the associated latest time; identify, from among the unfulfilled requests, one or more unfulfilled requests for which its lowest predicted cost of fulfilment is at a time matching the current time; and transmit a request to a resource supplier of the respective resource to fulfil the identified one or more unfulfilled requests.

In yet another aspect, the present application discloses a non-transitory, computer-readable medium storing computer-executable instructions that, when executed by a processor, are to cause the processor to carry out at least some of the operations of a method described herein.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . and . . . ” is intended to cover any one or more of the listed elements, including any one of the listed elements alone, any sub-combination, or all of the elements, without necessarily excluding any additional elements, and without necessarily requiring all of the elements.

In the present application, the term “fulfilment” refers to providing a requested resource to a requestor. It may be synonymous with “delivery” or “provisioning” or “transferring” in certain contexts.

In certain systems, a server or other computing platform may be configured to receive a plurality of requests for resources where each request has an associated “latest fulfilment time”, where the latest fulfilment time indicates a time and/or date that is the latest time at which fulfilment of the request should or may occur. The latest fulfilment time may be a hard deadline in some contexts, where the deadline is imposed by timing of a process or sequence, a contract, logistics, or otherwise. A hard deadline latest fulfilment time may indicate that fulfilment cannot logically or physically occur after that time or that fulfilment after that time would result in additional costs, penalties, or other requirements. The latest fulfilment time may be a “soft” or targeted deadline in some contexts, where the fulfilment may occur after the latest fulfilment time without additional costs or defined impact, but that may result in requestor disappointment or annoyance or in process delay or degradation.

In the context of the present application a request for resources to the computing platform is one that is fulfilled by an external resource fulfilment source, rather than by the computing platform itself. In this sense, the computing platform must request or instruct the external resource fulfilment source to complete fulfilment of the request to the requestor by provisioning or providing the requested resource. In this respect, the computing system acts as a control system for the requesting and directing of resources, such as for facilitating an industrial process, a computational process, or some other process.

The present application describes systems and methods for the computing platform to determine when to instruct or request that the external resource fulfilment source complete fulfilment of a particular resource request. The resource requested may be a product or a service, where that product or service is offered by the external resource fulfilment source. The computing platform may perform the role of a broker of the third party services/products, a coordinator, and/or a payment portal.

In one example, the request for resources may be a request from a computing device for an allocation of computing resources. For example, the request may be sent to a central server that is configured as a broker of available external processor time on third party computing systems. The request may be for a certain length of time or number of processor cycles. The central server may be tasked with instructing one of the third party computing systems to supply the requested computing resources.

In another example, the request is for memory storage capacity from a computing device to a central server that acts as a broker of third party data storage capacity. The central server may be tasked with instructing one of the third party data storage facilities to make the requested memory capacity available to the central server.

In further example, the request is for computing distribution services, such as a content delivery network provider. The request may be for distribution of a software update package, multimedia release, or other digital asset. The central server or platform may act as a coordinator and/or broker in selecting and instructing a third-party content delivery network provider to distribute or make available the digital asset, in accordance with the release schedule or time frame specified in the request.

In yet another example, the request relates to resources for an industrial process, such as a manufacturing or chemical synthesis process. The request may be for inputs to the process, such as certain parts, raw materials, quantities of chemical substances, or the like. The central server or platform may be a control system or controller for the industrial process in ensuring sufficient and timely inputs to the process are provided to enable efficient completion of the process without delays and without cost or spoilage associated with warehousing or otherwise handling unneeded materials.

In yet a further example, the request is for a deliverable product, and the central server or platform may be an e-commerce platform that provides merchants with services to market products, receive orders, and process payment. In this example, the merchant may not have its own inventory of product to fulfil orders but may rely on third-party sources to obtain the product after a request is received. This may be termed “drop-shipping” in some cases. In this model, the merchant receives an order on the e-commerce platform for the product and, after the order is received, the merchant in turn requests, via the e-commerce platform, that a drop-shipper—e.g. third party source of the product—fulfil the order by shipping the product to the original requestor.

In the present application, the term “e-commerce platform” refers broadly to a computerized system (or service, platform, etc.) that facilitates commercial transactions, namely buying and selling activities over a computer network (e.g., Internet). An e-commerce platform may, for example, be a free-standing online store, a social network, a social media platform, and the like. Customers can initiate transactions using a user computing device, and any associated payment requests, via the e-commerce platform, and the e-commerce platform may be equipped with transaction/payment processing components or may delegate such processing activities to one or more third-party services. An e-commerce platform may be extendible by connecting one or more additional sales channels representing platforms where products can be sold. In particular, the sales channels may themselves be e-commerce platforms, such as Facebook Shops™, Amazon™, etc.

In the above examples, the requestor submits a request for a resource, e.g. a product or service, to a central server or platform. The request has an associated latest fulfilment time. This may be a specified latest fulfilment time for provisioning of the service or for delivery of the product, for example. If the latest fulfilment time is in the future, it may afford the central server or platform the flexibility to defer ordering fulfilment from the external resource fulfilment source for some period of time. However, in these examples, because the central server or platform does not own or control the external resource fulfilment source that is relied upon to actually fulfil the request, it is subject to the risk of changes in cost associated with the external resource fulfilment source. If the original request from the requestor is accepted by the central server or platform at a specific cost, then the margin may vary if the eventual cost of fulfilment by the external resource fulfilment source varies once the order is placed. Accordingly, the lowest risk approach is to place the order for fulfilment with the external resource fulfilment source as soon as the request is received.

In some situations, immediately placing the order for fulfilment with the external resource fulfilment source may have negative implications. For instance, if a large quantity or spike in requests for a service or product are received in a short time period, a corresponding large quantity or spike in orders may be sent to the external resource fulfilment source. This may overwhelm some sources, result in changes in cost or rejection of some orders, or result in failure of some services. As an example, a sudden large quantity of orders to a content delivery network may overwhelm available resources and result in refusal of some requests and/or a deterioration in quality of service, due to overwhelming of bandwidth or processing resources available. This may occur despite the fact the requests have associated latest fulfilment times that could permit deferral of some orders to the external resource fulfilment source.

Accordingly, to mitigate the potential for negative impacts on product or service fulfilments the orders to external resource fulfilment sources may be deferred if permitted by the associated latest fulfilment times. In order to do so without imposing additional cost and risk of failure on the central server or platform, the present application provides systems and methods for automating the processing of order for fulfilment request processing and, in particular, the timing of processing such orders. The automation may include determining, for each request, predicted cost at a plurality of times between a current time and a latest order time. The latest order time is the latest fulfilment time or a time prior to the latest fulfilment time that accounts for a fulfilment latency time.

In the present application, the term “predicted cost” refers to a cost of fulfilment at a future time. The cost may refer to a cost of the product or service and any additional associated costs whether from the external resource fulfilment source or from an associated third party partner. Examples of associated third party partners may include a delivery partner, such as a shipping service for a product, or a telecommunication company in the case of a computing service provided over a communications link for which there are associated costs. Costs may include monetary costs in some cases. Costs may include non-monetary costs, such as time, bandwidth, memory space, etc.

A “predicted cost” may partly be based on the price of the product or service as set by the external resource fulfilment source from time-to-time. That price may fluctuate over time. The associated costs factored into predicted cost may include shipping or provisioning cost, which may be fixed or may fluctuate over time. The shipping or provisioning cost may vary depending on modality and/or location and/or product or service characteristics (e.g. size, quantity, bandwidth, speed, etc.), but may in some cases be fixed for a combination of modality, location, and/or product or service characteristics while the price of the product or service may be expected to vary over time.

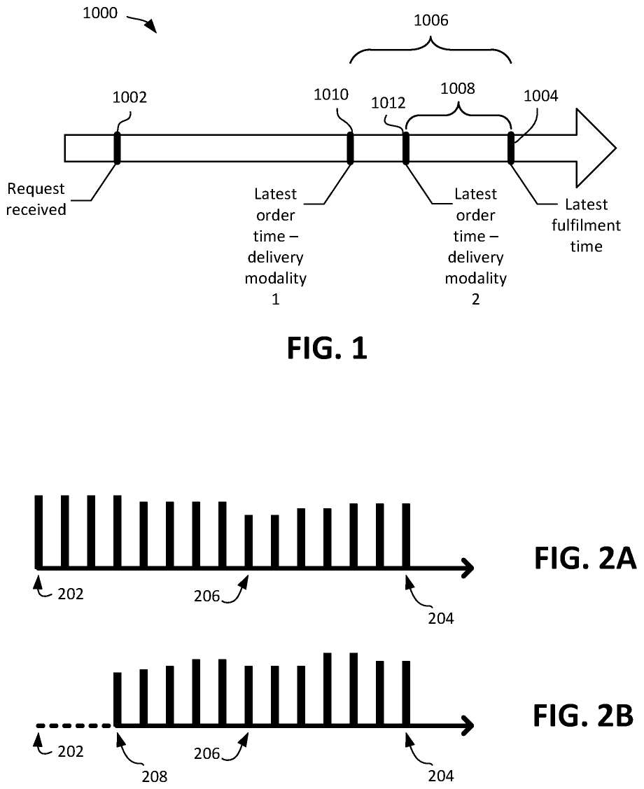

Reference is now made to FIG. 1, which diagrammatically illustrates an example timeline 1000. The example timeline 1000 includes a first time 1002 at which a request is received by a central server or platform. The request is received from a requestor device. The requestor device may include a remote computing device configured to connect to the central server or platform via a computing network to submit the request. The request includes an associated latest time for fulfilment, as indicated by reference numeral 1004. The latest time for fulfilment may be selected by the requestor when submitting the request in some implementations. The latest time for fulfilment may be generated and set by the central server or platform in some cases. In some instances, the central server or platform may provide two or more latest times for fulfilment to the requestor device for selection. The two or more latest times for fulfilment may correspond to different delivery modalities or different pricing options in some cases.

In some implementations, a delivery modality, such as shipping type, may have an associated latency. In some cases, the length of the associated latency depends on both the modality and a delivery location. In the case of a network-based delivery of multimedia deliverables, the latency may be in terms of seconds, minutes or hours. In the case of physical products and shipping, the latency may be in terms of days or hours.

As indicated, a first modality may have a first latency 1006 and a second modality may have a second latency 1008. In some cases, the second modality may have a shorter latency but a higher associated cost. As an example, regular ground shipping of a product may have a multi-day latency, but higher-cost express courier shipping may have a one day or same day latency. It will be appreciated that in some cases there may be only one delivery modality or in some cases there may be more than two modalities. In some cases, there is no latency associated with a modality.

In this example, the first latency 1006 establishes a first latest order time 1010, based on the latest time for fulfilment 1004 less the first latency 1006. This indicates the maximum that an order may be delayed and still rely on the first modality to meet the latest time for fulfilment 1004. Similarly, the second latency 1008 establishes a second latest order time 1012, based on the latest time for fulfilment 1004 less the second latency 1008.

The time span between the first time 1002 at which the request is received and the first latest order time 1010 provides a series of possible times at which the central server or platform could transmit the order for the product or service to the external resource fulfilment source. The times may be evenly spaced, in some implementations. In one example the series of times are one per day for each day between and including the first time 1002 and the latest order time 1010. In some other examples the series of times are hourly, each minute, or each second.

Because the pricing set by the external resource fulfilment source may be time variant, the predicted cost may vary with time. The variation may be known to the central server based on a price schedule from the external resource fulfilment source in some cases. However, in many cases the time-based variation in pricing from the external resource fulfilment source may not be fixed in advance and/or known to the central server. Accordingly, the central server may generate a predicted pricing for the product or service. The predicted pricing may include a series of discrete predicted prices at each of the times in the time series.

Based on the predicted pricing and any associated costs, the central server may then determine the time within the time series at which the predicted cost of the order is the lowest. In one implementation, the central server then waits until that time and places the order. In some cases, the central server may monitor signals relating to the predicted pricing, such as related sales metrics on the central server platform, and may identify whether those metrics indicate a greater-than-threshold change in circumstances which then triggers re-running of the predicted cost analysis to assess whether the identified time is still the optimal time, i.e. the time with the lowest predicted cost.

In another implementation, the central server re-runs the predicted cost analysis at every time in the time series and generates and transmits the order to the external resource fulfilment source whenever the current time is identified as the lowest predicted cost of all remaining times.

FIG. 2A illustrates one example series of predicted cost for a product or service. The series spans from a first time 202 at which the request for the product or service is first received by the central server to a latest order time 204 determined by the central server based on a latest fulfilment time and any latency associated with a fulfilment modality. It will be noted that the central server determines a predicted cost of the product or service from the external resource fulfilment source at each time in a series of times that includes the first time 202 and the latest order time 204.

In the example series, it will be noted that the lowest predicted cost determined by the central server occurs at a time indicated by numeral 206. On this basis the central server may determine not to transmit an order for the product or service to the external resource fulfilment source at the first time 202 when the request is first received. Instead, the central server may schedule an order to be transmitted at the time 206 when the predicted price is anticipated to be lowest.

FIG. 2B illustrates another example series of predicted cost for a product or service. In this example, the predicted cost has been determined for the same product or service and in response to the same request received at the first time 202, but the prediction in this example is determined later at a current time 208. When the predicted cost is re-determined at the current time 208, the predicted cost varies from the predicted cost previously determined and shown in FIG. 2A.

The re-determination may be a routine re-calculation of predicted cost that the central server carries out at each time, or may have been triggered by the central server detecting a change in a metric related to cost prediction in connection with the product or service. The re-determination indicates that the predicted cost at time 206 is no longer the lowest predicted cost in the time series. The predicted cost at time 206 is now higher such that the lowest predicted cost now occurs at the current time 208. On that basis, at the current time 208 the central server generates and sends an order for fulfilment of the product or service request to the external resource fulfilment source.

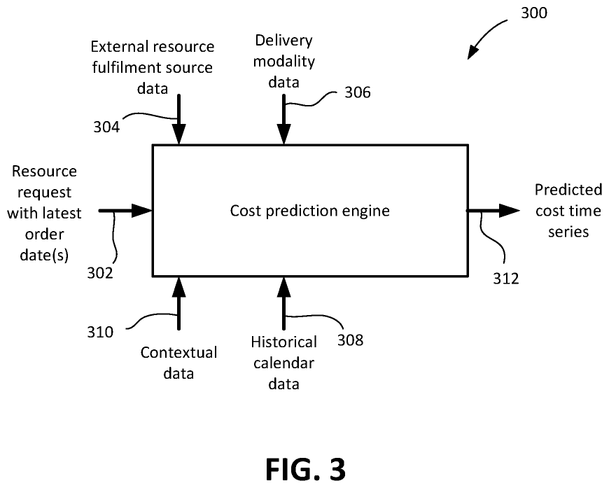

The central server may include a cost prediction engine 300, an example illustration of which is shown in FIG. 3. The cost prediction engine 300 may employ a set of logic rules in one implementation, wherein the logic rules are applied to a set of input signals to produce a series of predicted costs for a resource request. In some implementations, the cost prediction engine 300 may incorporate machine learning, such as an artificial intelligence component, configured to produce the series of predicted costs for a resource request. The machine learning function may include a feedback loop receiving historical and current cost data with regard to resource requests to train and refine the predicted cost model.

As shown, the cost prediction engine 300 may receive a number of inputs, including the resource request data 302. The resource request data 302 may include identifying information for the product or service, data regarding its category or industry, data regarding the external resource fulfilment source or sources for obtaining the product or service, and the latest order date or dates determined by the central server for ordering the product or service, which may include an associated delivery modality.

The cost prediction engine 300 may receive external resource fulfilment source data 304. This may include a current price for the product or service and/or availability data for the product or service from a computing device associated with the external resource fulfilment source, such as an order submission website, portal, or API. The external resource fulfilment source data 304 may include other data relating to the external resource fulfilment source and/or its pricing model in some cases. For example, the data 304 may include historical pricing data for the product or service in some cases. The data 304 may include scheduled sales or discounts and associated timing data. The data 304 may include sales volume data or trends for the product or service, the industry or product/service category, or the external resource fulfilment source overall. The data 304 may include any other signal or data relating to the external resource fulfilment source that may be connected to or correlated with future pricing changes.

In some instances, the cost prediction engine 300 may receive delivery modality data 306. The delivery modality data 306 may include data from one or more shipping services or other delivery mechanisms. That data may include cost schedules and/or timing.

In some cases, the cost prediction engine 300 may further receive historical calendar data 308 from a source other than the external resource fulfilment source. The historical calendar data 308 may include historical sales volume, pricing, or other sales-related metrics specific to the product or service or the product/service category or industry. The historical calendar data 308 may be a record of pricing or sales or other commercial metrics specific to the external resource fulfilment source stored and available from a third party source. The historical calendar data 308 may be a record of pricing or sales or other commercial metrics for a category or industry of sources relating to the product or service or the external resource fulfilment source. The historical calendar data 308 may include year-over-year sales, pricing, or other commercial metrics indicative of trends or patterns in price or sales changes on a calendar basis.

The cost prediction engine 300 may further receive contextual data 310. The contextual data 310 may include any external data source relating to factors or signals that are connected to or correlated with changes in pricing. The contextual data 310 may include news reports, weather data, social media posts or trends, or other such event-related data identified as trending or otherwise the subject of significant online activity above a threshold of relevancy. In some cases, the contextual data 310 may be correlated to subsequent changes or trends in pricing of certain products or services. As an example, a trend indicative of a significant weather event, such as a significant hurricane in a particular region may indicate a likely increase or decrease in the price of certain goods or services in that region. As another example, a trending spike in searches for a particular product or service or reposting of a celebrity endorsement of a particular product or service may be correlated to a likely increase in sales volume of that product or service and possible price increases. Other correlations to price movement may be obtained from other types of contextual data 310.

The cost prediction engine 300 is configured to receive the inputs from the various data sources and to provide a predicted cost series 312. The predicted cost series 312 indicates the predicted cost of ordering the product or service from a particular external resource fulfilment source at a series of time points from a current time to the latest order time specified by the resource request data 302.

The cost prediction engine 300 may be configured to develop and store a pricing model applicable to a particular external resource fulfilment source and/or product or service. The pricing model may generate the predicted cost series 312 in response to a set of input data sources.

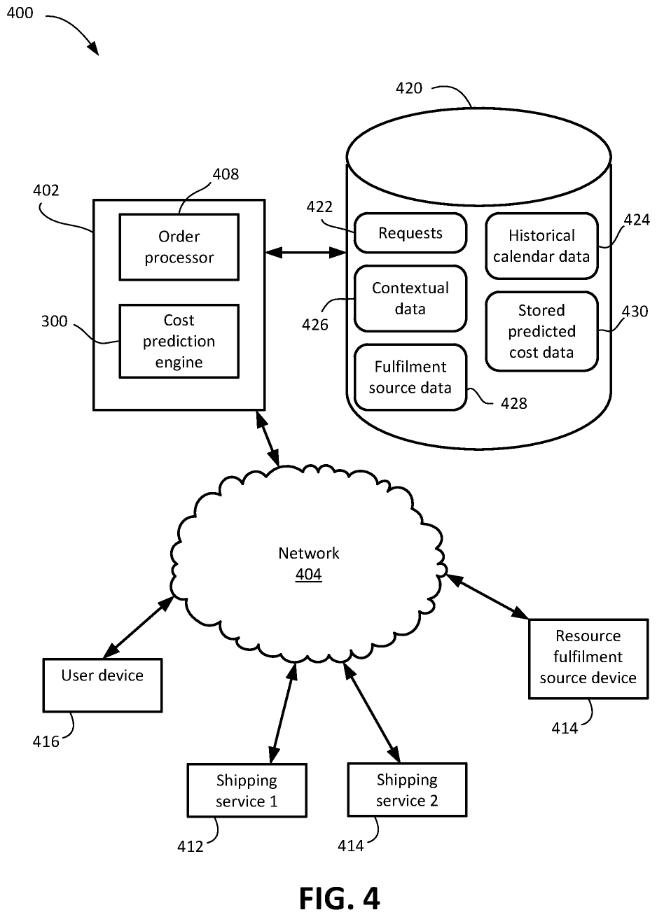

Reference is now made to FIG. 4, which diagrammatically illustrates an example system 400 for automated request fulfilment processing. The system 400 may include a central server 402 connected to a computing network 404. The central server 402 may serve as a controller or control system for the processing of requests. The central server 402 may be configured to receive resource requests and control their dispatching to modulate request rates in some cases. The computing network 404 may include one or more public and/or private networks, including the Internet. A user device 406 may be configured to generate and send a resource request to the central server 402 via the network 404.

The system 400 may further include a resource fulfilment source device 410 connected to the network 404 and to which the central server 402 may direct an order for a product or service. In some cases, the central server 402 is further capable of obtaining data from the resource fulfilment source device 410, such as fulfilment source data 428. The fulfilment source data 428 may include current pricing data, future sales or pricing data, historical sales or pricing data, or other data relating to commercial metrics of the resource fulfilment source. In some cases, the fulfilment source data 428 includes inventory levels, expiry dates, and other resource-related data.

The system 400 may include one or more shipping services 412, 414. In some examples, the central server 402 may be able to obtain data from the one or more shipping services 412, 414. The data may include shipping rates and/or times.

The central server 402 may include, among other components not illustrated, an order processor 408 for receiving a resource request from the user device 406 and for determining when to generate and send a corresponding order to the resource fulfilment source device 410. The central server 402 may include the cost prediction engine 300, which provides a predicted cost series to the order processor 408 to enable the order processor 408 to determine when to generate and send an order.

The central server 402 may further include data storage 420. The data storage 420 may include a single storage media or a plurality of storage media. The data storage 420 may be logically structured as one database or as many databases in some implementations. The data storage 420 may store various items including request data 422, historical calendar data 424, contextual data 426, the fulfilment source data 428, and stored cost prediction data 430.

The request data 422 may include resource requests received from the user device 406 or other user devices. The stored request data 422 may include an account or user identifier, address data, a product or service identifier, and latest fulfilment time data. In some cases, the request data 422 may include one or more latest order times and/or delivery modalities associated with the resource request as determined by the order processor 408.

The historical calendar data 424 may include historical sales volume, pricing, or other sales-related metrics specific to the product or service or the product/service category or industry. The historical calendar data 424 may be a record of pricing or sales or other commercial metrics specific to the external resource fulfilment source stored and available from resource fulfilment source device 410 or from a third party source. The historical calendar data 424 may be a record of pricing or sales or other commercial metrics for a category or industry of sources relating to the product or service or the external resource fulfilment source. The historical calendar data 424 may include year-over-year sales, pricing, or other commercial metrics indicative of trends or patterns in price or sales changes on a calendar basis.

The contextual data 428 may include any external data source relating to factors or signals that are connected to or correlated with changes in pricing. The contextual data 428 may include news reports, weather data, social media posts or trends, or other such event-related data identified as trending or otherwise the subject of significant online activity above a threshold of relevancy. In some cases, the contextual data 428 may be correlated to subsequent changes or trends in pricing of certain products or services.

The stored cost prediction data 430 may include one or more predicted cost series generated by the cost prediction engine 300. The stored cost prediction data 430 may provide a record of previous predictions and/or the metrics on which the previous predictions are based, to assess whether new signals or metrics indicate a deviation of more than a threshold. For example, the stored cost prediction data 430 may include a predicted cost series that enables the central server 420 to compare current price data from the resources fulfilment source device 410 to what the cost prediction engine 300 has predicted the cost would be. A deviation of more than a threshold amount, e.g. 5-10%, may trigger a re-determination of the predicted cost of that product or service.

In some cases, the resource request may be specific to purchase of a product or service through an e-commerce platform. That is, in some implementations the central server 402 may be an e-commerce platform, an example of which is described in further detail later. For the purposes of this example, the e-commerce platform may include one or more computing devices, such as servers, that facilitate online commerce. In one example, the e-commerce platform may include a web server hosting an online commerce portal for a single merchant. In some examples, the e-commerce platform may include a web server hosting a plurality of online commerce portals or websites for a plurality of merchants. In some cases, the e-commerce platform is a server supporting a social network or other multi-user application that has a commerce component through which multiple different merchants may build and provide online “stores” through which users of the social network application may browse and purchase products. In some cases, the e-commerce platform is a dedicated e-commerce platform designed to host a plurality of merchants and enable them to build and design their virtual storefronts.

In this example, the external resource fulfilment source may be a dropshipper, i.e. an external supplier of the product or service, such as a wholesaler. The shipping services 412, 414 may include postal or courier or other delivery services.

In this example, the data storage 420 may further include merchant data. The merchant data may include data relating to merchants, their online stores, product items, customer data, sales data, or other data relating to e-commerce activity on the e-commerce platform.

The user device 406 may include a browsing application. The browsing application may include a generic web browser in some implementations, a merchant-specific browsing application in some implementations, a social media application in some implementations, or a dedicated e-commerce application in some implementations. Using the browsing application, the user device 406 may establish a browsing session with the e-commerce platform. The connection may include the exchange of identifying data, such as user credentials, in some cases. The connection may include establishing an active session, such as an HTTP or HTTPS session, with the e-commerce platform. In some cases, the session may relate to a specific merchant, such as when the browsing application is used to navigate to a domain or subdomain associated with that merchant at which the merchant's online product offerings are made available for browsing, selection, and purchase.

Further details regarding an example e-commerce platform are described below. It will be appreciated, however, that the present application is not necessarily limited to application in an e-commerce environment. Nevertheless, the e-commerce environment is a conveniently illustrative one and will be referenced in the description below.

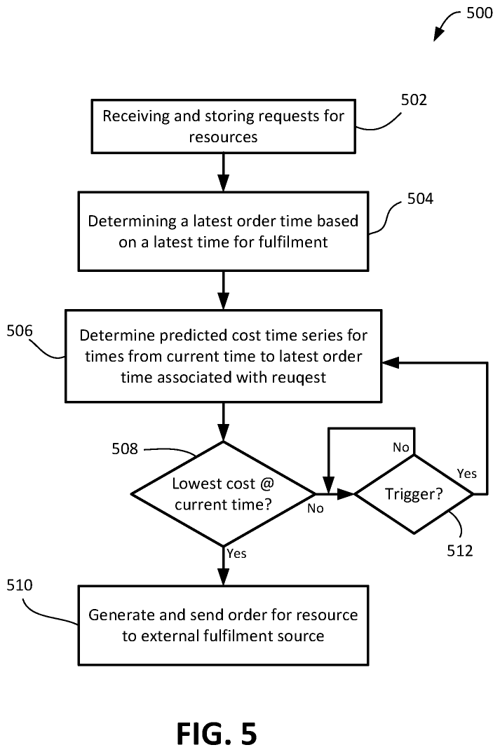

Reference will now be made to FIG. 5, which shows, in flowchart form, one example method 500 for automated request fulfilment processing. The method 500 may be implemented by a computing device having suitable computer-executable instructions for causing the computing device to carry out the described operations. The method 500 may be implemented, in whole or in part, using one or more servers implementing the central server 402 (FIG. 4), such as those implementing an e-commerce platform. The method 500 may be carried out by the order processor 408 (FIG. 4) and/or cost prediction engine 300 (FIG. 3), which themselves may be implemented by way of processor-executable instructions stored in memory at one or more servers and which, when executed by one or more processors causes the one or more servers to carry out the described operations.

The example method 500 includes receiving and storing a resource request in operation 502. The resource request in this example may be a product purchase request received by an e-commerce platform. The request may be received via a merchant's online store through which the merchant offers one or more products that they do not manufacture or own and which they do not have in current inventory. Accordingly, the merchant may price the product based on what the merchant anticipates it might cost them to acquire the product in order to fulfil the purchase request. The e-commerce platform may not be involved in setting or determining the price at which the merchant offers the product.

The resource request includes related data, such as a delivery address or location and a latest fulfilment time, e.g. a latest delivery date in this example. The latest fulfilment data may be based on a merchant-configured target delivery window by which the merchant has specified a maximum delivery latency. For instance, the merchant may have set two weeks as the maximum latency time. In some cases, the merchant may offer delivery options, which may correspond to different delivery modalities such as express, courier, regular mail, etc., on its online store and the requestor may select a preferred option. The selected option may set the latest delivery date. The latest delivery date may or may not be displayed to the requestor. In the latter case, the latest delivery date may be an internal one set by merchant policy. The related data for the resource request may include a delivery modality if one has been specified or selected.

Having accepted and received payment for the product, the merchant's online store may execute an API call or other software trigger to the order processor 408 or a similar component to manage processing of an order for the product from a third party supplier. One or more third party suppliers may be specified by the merchant in some cases; or the merchant may have identified a designated third party supplier of the product.

The system stores the resource request and any associated or related data, such as the delivery location or address, any specified delivery modality, and the latest delivery date. If no latest delivery date is specified, the system may set a default latest delivery date, such as one or two months.

In operation 504, the system determines one or more latest times for fulfilment of the request, e.g. one or more latest order dates in this example. The latest order dates specify the last date on which an order may be placed with the third party supplier such that the ordered product may be expected to be delivered by the latest delivery date based on the delivery address and associated delivery modality. Each latest order date may be based on a specified delivery modality. If only one delivery modality, e.g. shipping type, is specified or is available, then the system determines one latest order date.

In operation 506, the system determines a predicted cost of fulfilment of the resource request, i.e. predicted cost of ordering the product from the third party supplier, with or without shipping cost added, at a series of dates from a current date to the latest order date. In some cases, the predicted cost is determined for each day from the current date to the latest order date. In some cases, the predicted cost is determined for a subset of days that includes the current date to the latest order date, such as weekdays or business days. In some cases, the predicted cost is determined more often than daily, such as at two or more times per day.

As described above, the determination of predicted cost in operation 506 may be based on logic rules, machine learning, or another prediction mechanism that takes into account current price data regarding the product from the third party supplier and one or more additional signals, such as calendar data, historical pricing trends or data, industry-wide trends or data, or other such factors.

The predicted costs may include shipping costs, particularly if the shipping costs are expected to vary over time. If the shipping costs for a given modality are fixed irrespective of order date, then the shipping costs may be omitted from the predicted cost in some implementations.

If more than one delivery or shipping modality is possible, then more than one time series of predicted costs may be generated. The different time series of predicted costs may include the different shipping costs associated with their respective shipping modalities.

In operation 508, the system assesses whether the time series of predicted costs indicates a lowest cost at a current time/date. If so, then the system processes and order for the product in operation 510. This may include transmitting an order message to a third party supplier website or portal for receiving electronic product orders. The order message may include a product identifier, any associated product order details, the delivery address and, in some cases, the selected shipping modality.

If the lowest predicted cost in the time series does not occur at the current time/date, then the system proceeds to operation 512 to await a trigger. In one example, the trigger is a change in date or time to the next time/date in the time series. At each time/date in the time series, the system returns to operation 506 to re-evaluate the predicted cost and re-assess whether the lowest predicted cost occurs at the now-current time/date. In another example, an alternative or additional trigger for re-evaluation may be detection of data prompting a re-evaluation. Example data includes pricing at the third party supplier. If the price of the product at the third party supplier changes and that change differs from the previously-predicted cost, then the system may re-evaluate predicted cost for the product. As another example, external signals such as volume of sales on the e-commerce platform, sales activity or volume in the industry, sales of particular products or classes, etc., may deviate from an expected level or trend to a degree that re-evaluation of the predicted cost is triggered on the basis that the assumptions and data on which the previous prediction was based have changed significantly.

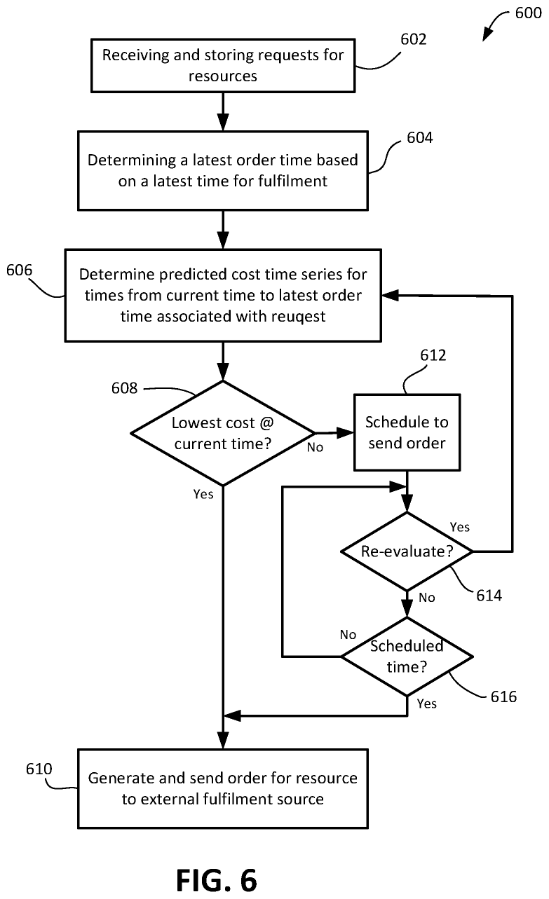

Reference is now made to FIG. 6, which shows another example of a method 600 for automated request fulfilment processing. As with the method 500 (FIG. 5), the method 600 may be implemented by a computing device having suitable computer-executable instructions for causing the computing device to carry out the described operations.

Operations 602, 604, 606, 608, and 610 generally correspond to operations 502, 504, 506, 508, and 510 of FIG. 5.

In this example method 600, if, in operation 608, the system determines that the lowest predicted cost is not the predicted cost for the current time, then in operation 612, the system identifies the time/date of the lowest predicted costs in the time series and schedules an order to be sent at that time/date. If more than one predicted cost is the lowest, then the system may select the earliest of them. After scheduling the order, the system then awaits the time/date for sending the order.

While waiting, the system assesses whether it detects a trigger to re-evaluate predicted cost, as indicated by operation 614. As noted above, the trigger may include detection of a change in external data by more than a threshold amount. External data may include data that served as an input or basis for generating the time series of predicted cost. Example external data may include the current price of the product from the third party supplier in one instance. If the current cost varies from the predicted cost by more than a threshold, such as 5% or 10% for instance, then the system may determine that the time series of predicted costs is to be re-determined in operation 606. Other example external data may include a change in relative shipping costs as between two modalities. Another example of external data may include a relative spike or drop in sales volume or quantity associated with the third party supplier via the e-commerce platform, whether for the product or for any product. The change in volume or trends in volume may correlate to future changes in pricing by the third party supplier. Other signals that correlate to future pricing changes may also or alternatively serve as external data triggers in operation 614.

If no re-calculation has been triggered, then in operation 616 the system assesses whether the scheduled time/date has been reached for sending the order. If not, it returns to operation 614. If the scheduled time/date has been reached then the order is generated and sent in operation 610.

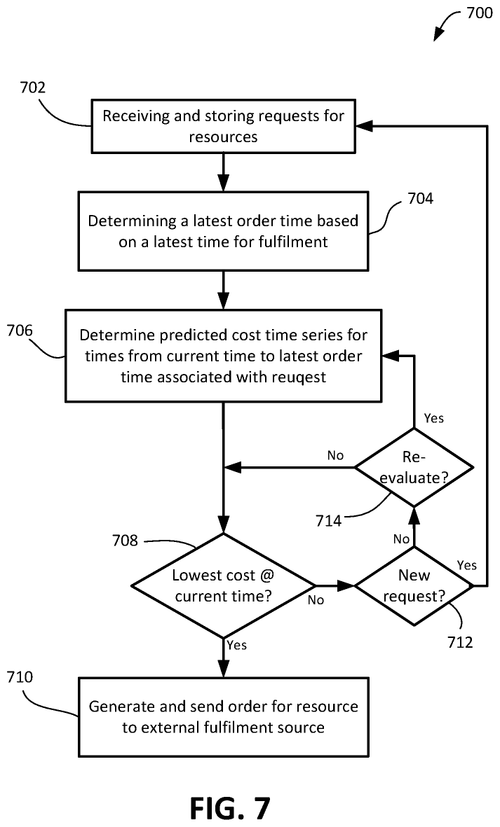

A further example method 700 is illustrated in FIG. 7. The example method 700 may be implemented by a computing device having suitable computer-executable instructions for causing the computing device to carry out the described operations. The example method 700 is a simplified illustration of the handling of multiple requests for resources.

In this example, operations 702, 704, 706, 708, and 710 generally correspond to operations 502, 504, 506, 508, and 510 of FIG. 5. However, in this example method 700 when the system determines the predicted cost in operation 706, the determination may be jointly made for two separate received requests for the same product from the same supplier. That is, in some cases, the predicted cost may be impacted based on multiple orders being jointly or collectively processed. In some cases, volume discounts or other price effects may be realized when processing two or more orders with the same third party supplier. In another example, more than one request may be received for products from the same third party supplier and having the same delivery address. The predicted costs of processing those orders may change if jointly ordered. In some cases, the shipping costs may be lowered if jointly ordered. In some cases, the requests may be associated with different requestor accounts but have the same delivery address, such as in the case where multiple user accounts are configured to receive deliveries at a single address. Accordingly, in operation 706 the system may be configured to determine the predicted cost by first determining whether there are associated received requests pending. Associated requests may be requests having the same delivery address and the same third party supplier in some cases. Associated requests may be requests for the same product from the same third party supplier but with different delivery addresses in some cases.

If associated requests are identified, then the system may jointly generate the time series of predicted costs for the two or more requests. In one example, the system may generate an individual time series of predicted costs for each of the two or more requests and generate a further time series of predicted costs based on joining of the two or more requests in a single order. The lowest predicted cost may then be identified. Obviously, the predicted cost in the further time series will be larger since the orders are combined, but the system may compare the pro rata predicted cost per product from the larger order with the predicted cost pre product from the individual orders to identify the lowest cost option and time/date. If the lowest cost is identified in the further time series, then the requests may be fulfilled by processing them jointly in a single order.

In operation 712, if the current time/date does not correspond to the time/date of the lowest predicted cost, then in operation 712 the system assesses whether a new request has been received. If not, then the system may determine in operation 714 whether a re-determination of predicted cost has been triggered. Example triggers are discussed above in connection with FIG. 5 and FIG. 6.

If a new request is detected in operation 712, then the method 700 returns to operation 702. When determining the predicted cost of fulfilling the new request in operation 706, the system may determine whether the new request is associated with any pending requests. If it is an associated request, then operation 706 may further trigger a re-determination of the predicted costs of those associated pending requests and an assessment of whether it would be advantageous to join one or more of the pending requests with the new request for joint order processing.

The above-described methods are illustrative simplified example processes. It will be appreciated that some of the described operations may be performed in a different order or in parallel, or that additional operations may be carried out, without departing or deviating from the overall thrust of the methods and their functional operation.

Although implementation on an e-commerce platform, as such, is not required, it may be illustrative to provide further details regarding the components and operations of one or more example e-commerce platforms.

### An Example e-Commerce Platform

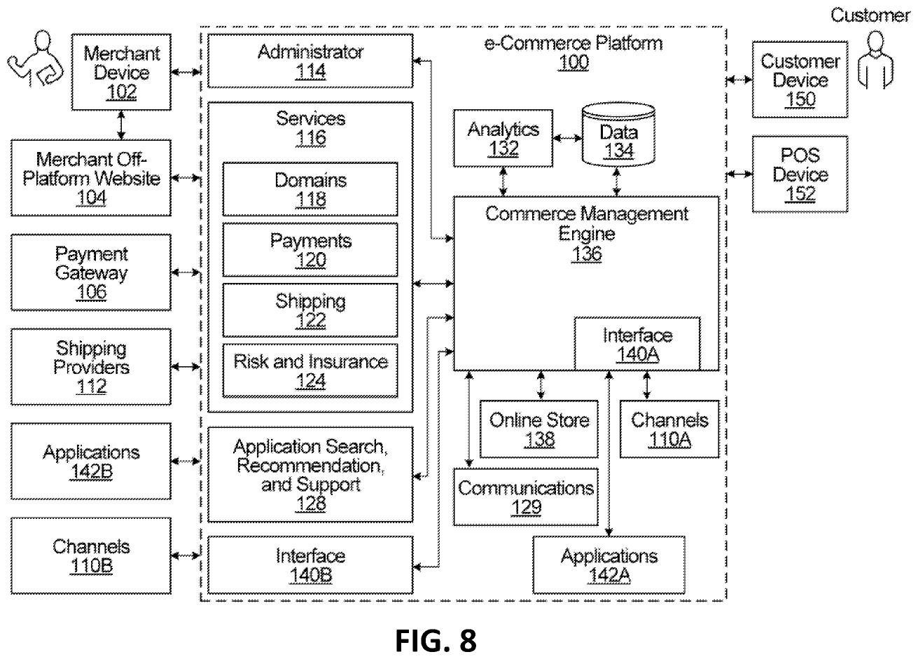

FIG. 8 illustrates the example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 8, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a transitory memory such as for example, random access memory (RAM), and/or a non-transitory memory such as, for example, a non-transitory computer readable medium such as, for example, persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data repository 134) such as, for example, through a network connected to the e-commerce platform 100. For example, the online store 138 may serve or send content in response to requests for data from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., in data repository 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfilment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

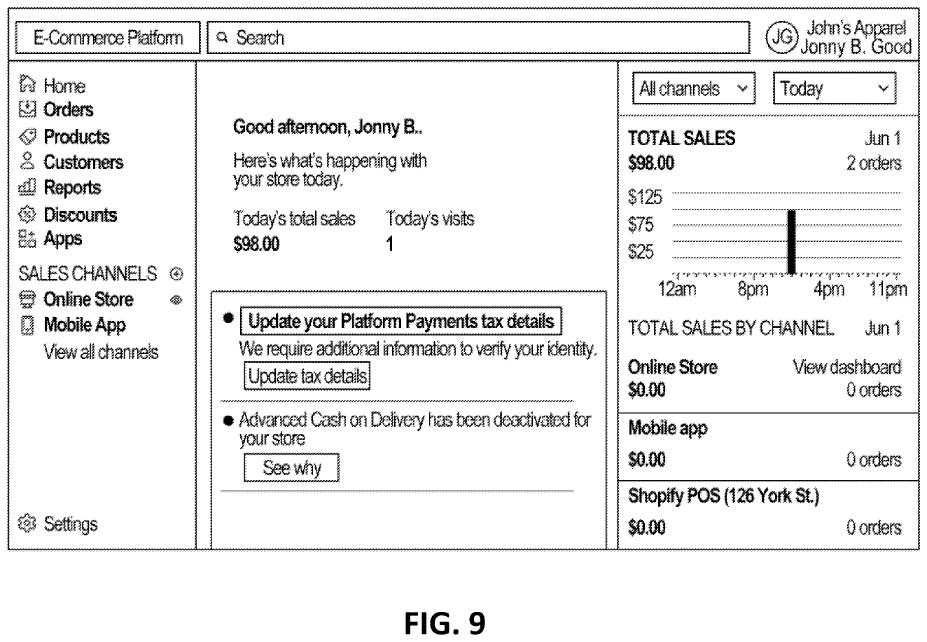

FIG. 9 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 9. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfilment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as, for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 8, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) to transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and tracks quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfilment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfilment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfilment component of the commerce management engine 136. The fulfilment component may group the line items of the order into a logical fulfilment unit of work based on an inventory location and fulfilment service. The merchant may review, adjust the unit of work, and trigger the relevant fulfilment services, such as through a manual fulfilment service (e.g., at merchant managed locations) used when the merchant picks and packs the products in a box, purchase a shipping label and input its tracking number, or just mark the item as fulfilled. Alternatively, an API fulfilment service may trigger a third-party application or service to create a fulfilment record for a third-party fulfilment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

### Implementations

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In some embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4th Generation (4G) networks (e.g., Long-Term Evolution (LTE)) or 5th Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer-implemented method, comprising:
receiving, by a computer system, a plurality of requests for resources, each request being for a respective resource and having an associated latest time; and
periodically, for unfulfilled requests among the plurality of requests:
determining, using a machine learning model, for each unfulfilled request, an predicted cost of fulfilment of the unfulfilled request at times between a current time and the associated latest time;
identifying, from among the unfulfilled requests, one or more unfulfilled requests for which its lowest predicted cost of fulfilment is at a time matching the current time; and
transmitting a request to a resource supplier of the respective resource to fulfil the identified one or more unfulfilled requests.

2. The method claimed in claim 1, wherein the associated latest time includes a latest order time, and wherein each request for resources includes a latest fulfilment time, and wherein the method further includes determining, for each request, its associated latest order time based on the latest fulfilment time less an expected latency time.

3. The method claimed in claim 2, wherein the expected latency time is an expected time from transmission of the request to the resource supplier to provisioning of the respective resource to a requestor associated with the request.

4. The method claimed in claim 3, wherein the expected time includes a shipping time and is based, in part, on a shipping modality, and wherein the resource supplier permits one or more shipping modalities for the respective resource.

5. The method claimed in claim 4, wherein each of the one or more shipping modalities has respective associated cost and expected latency time, and wherein determining includes selecting one of the one or more shipping modalities having an expected latency time that would result in provisioning of the respective resource to the requestor within the latest fulfilment time.

6. The method claimed in claim 1, wherein determining predicted cost of fulfilment includes determining a first predicted cost of fulfilment of a first of the unfulfilled requests and determining a second predicted cost of fulfilment of the first of the unfulfilled requests if combined with a second of the unfulfilled requests directed to the same identified resource.

7. The method claimed in claim 1, wherein the predicted cost of fulfilment includes determining a predicted supplier price for the respective resource at a future time and a predicted delivery cost.

8. The method claimed in claim 7, wherein the predicted delivery cost includes a predicted shipping cost.

9. The method claimed in claim 7, wherein the predicted supplier price is at least partly based on a current price and a supplier pricing model associated with the resource supplier.

10. The method claimed in claim 9, wherein the supplier pricing model is based on one or more of calendar data and year-over-year historical pricing data.

11. The method claimed in claim 10, wherein the supplier pricing model is further based on one or more of sales volume data relating to the respective resource, order volume data associated with the resource supplier, industry volume data for an industry related to the respective resource, year-over-year historical pricing data associated with an industry related to the respective resource, year-over-year historical pricing data associated with the respective resource, or year-over-year historical pricing data associated with the resource supplier.

12. The method claimed in claim 1, wherein periodically includes daily, the current time is a current day, the associated latest time is an associated latest date, and wherein determining the predicted cost of fulfilment of the unfulfilled request at times includes determining the predicted cost of fulfilment of the unfulfilled request at dates from the current day to the associated latest date.

13. The method claimed in claim 1, periodically includes at a time when a trigger event is detected.

14. The method claimed in claim 13, wherein the trigger event includes detecting a deviation in current cost of fulfilment from a previously-predicted cost of fulfilment at the current time by more than a threshold amount.

15. A computing system, comprising:
a processor;
a memory storing computer-executable instructions that, when executed by the processor, are to cause the processor to:
receive a plurality of requests for resources, each request being for a respective resource and having an associated latest time; and
periodically, for unfulfilled requests among the plurality of requests:
determine, using a machine learning model, for each unfulfilled request, an predicted cost of fulfilment of the unfulfilled request at times between a current time and the associated latest time;
identify, from among the unfulfilled requests, one or more unfulfilled requests for which its lowest predicted cost of fulfilment is at a time matching the current time; and
transmit a request to a resource supplier of the respective resource to fulfil the identified one or more unfulfilled requests.

16. The computer system claimed in claim 15, wherein the associated latest time includes a latest order time, wherein each request for resources includes a latest fulfilment time, and wherein the instructions, when executed, are to further cause the processor to determine, for each request, its associated latest order time based on the latest fulfilment time less an expected latency time.

17. The computer system claimed in claim 15, wherein the predicted cost of fulfilment is based on a predicted supplier price for the respective resource at a future time and a predicted delivery cost.

18. The computer system claimed in claim 17, wherein the predicted supplier price is at least partly based on a current price and a supplier pricing model associated with the resource supplier.

19. The computer system claimed in claim 15, wherein periodically includes daily, the current time is a current day, the associated latest time is an associated latest date, and wherein determining the predicted cost of fulfilment of the unfulfilled request at times includes determining the predicted cost of fulfilment of the unfulfilled request at dates from the current day to the associated latest date.

20. A non-transitory, computer-readable medium storing computer-executable instructions that, when executed by a processor, are to cause the processor to:
receive a plurality of requests for resources, each request being for a respective resource and having an associated latest time; and
periodically, for unfulfilled requests among the plurality of requests:
determine, using a machine learning model, for each unfulfilled request, an predicted cost of fulfilment of the unfulfilled request at times between a current time and the associated latest time;
identify, from among the unfulfilled requests, one or more unfulfilled requests for which its lowest predicted cost of fulfilment is at a time matching the current time; and
transmit a request to a resource supplier of the respective resource to fulfil the identified one or more unfulfilled requests.
